(19) United States
(12) Patent Application Publication
(10) Pub. No.: US 2014/0211020 A1
(43) Pub. Date: Jul. 31, 2014

(54) Video Capture Attachment and Monitor for Optical Viewing Instrument

(71) Applicant: William Henry Johns, JR., Stone Mountain, GA (US)

(72) Inventor: William Henry Johns, JR., Stone Mountain, GA (US)

(21) Appl. No.: 14/164,070

(22) Filed: Jan. 24, 2014

Related U.S. Application Data
(60) Provisional application No. 61/756,514, filed on Jan. 25, 2013.

(51) Int. Cl. H04N 5/30

(52) U.S. Cl. CPC H04N 5/30
USPC 348/162

(57) ABSTRACT

The present invention is an attachable and detachable video image capture and display instrument that comprises a digital video capture device that can easily be physically connected to a gun scope, spotting scope, telescope, microscope, monocular, binocular or other optical viewing instrument or optical instrument used for viewing or examining an object or scene. It has electronic output to a display device, recording instrument, computing instrumen video projection devise, or data transmission instrument by way of connections of various options including wires, blue tooth, cellular, or other methods of video and audio data transmission. The video data coming into the optical instrument can be viewed while it happens on various display monitors that are physically mounted to the optical instrument, or not physically mounted to the optical instrument. The image capture mode can he black and white, color, 3 dimensional, night vision, thermal vision, and all other imaging modes available in the industry. This device is capable of video output of image data that can be integrated with computer applications that use image technologies with examples including image recognition and motion detection algorithms.

### CROSS-REFERENCE TO RELATED APPLICATION

This application claims the benefit of U.S. Provisional Patent Application Ser. No. 61/756514, filed Jan. 25, 2013.

### BACKGROUND OF THE INVENTION

1. Field of the Invention

The present invention comprises various embodiments of an optical imaging device related generally to a camera attachment for optical viewing instruments which is attachable and removable, or mechanically positioned with the ocular lens of an optical viewing instrument to capture real-time images that are projected through the lenses and convert the images into digital data that can he output to a viewing monitor, recording instrument, computing instrument, or transmitting device. The present optical instrument attachment enables a person or persons to view the images coming through the optical viewing instrument on a monitor that replaces the need for a person to physically look through an eye piece, and the image data can be stored or used in computing applications.

The invention further comprises a monitor that can he mounted on a scope or scoped devise or detached from it, The monitor can he mounted in such a way as to allow the monitor to swivel relative to the scope's line of sight which increases the angles a scope can he used at. The invention is operable to capture real-time images that are projected through the ocular lens and to convert the images into digital data that can be output to a viewing monitor, recording instrument, computing instrument, or transmitting device. The video images captured by the camera can be from visible and invisible light spectrums and can be displayed in a variety of display modes (e.g., black and white, color, night vision, thermal vision, etc.).

Hereto it has been impossible to easily convert a conventional rifle scope or other optical scope into a scope with video display capabilities, IR night vision capabilities, starlight vision capabilities, or thermal vision capabilities. Hereto in order for a hunter to add video display to a scope the camera would have to be attached to the scope and the display is in a fixed position relative to the scope. Many existing traditional scopes are made of high quality materials and craftsmanship, Hereto there has been no way to easily add an attachment to a scope that inherits the scopes capabilities and enhances them with the visual imaging and display capabilities of the micro board camera industry which is growing and advancing in areas of low light, Infra-Red night vision, starlight vision, thermal vision, and expanding micro board camera capabilities not yet implemented.

It is therefore a primary objective of this invention to provide an imaging device attachment for a scope that enhances the original scope device with a video capture capability that enhances the original scope with the visual imaging capabilities of the micro board camera industry and video image display instrument industry. A standard optical scope will no longer be limited to the ability of the human eye to perceive visible light images through an optical eye piece. This scope attachment in mention captures images from visible and invisible light coming through a scope eyepiece and can displayed, or output it as visible video.

A discussion of the related art of which the present inventor is aware, and its differences and distinctions from the present invention, is provided below.

U.S. Pat. No.: 7,292,262. Towery et al.

Towery describes a firearm sight that is operable to save an image of a target and reticle from a single point in time. While Towery describes the element of saving an image of a target 3 and reticle, nothing in Towery discloses a sight operable to save or transmit digital video images, a camera attachment that is operable to attach to an optical device, or a display device, that can be attached to an optical device.

U.S. Pat. No.: 4,835,621. Black

Black merely describes a video camera recording device that has a support structure that is similar to the support structure of a firearm. While Black describes a video recording device in conjunction with a gun-like structure, Black fails to disclose a means for attaching a camera device to an optical sight, or a display device for displaying images recorded by the camera device.

U.S. Pat. No.: 7,810,273. Koch et al.

Koch describes a digital video camera attached to a firearm and a video screen that displays images recorded by the video camera. However, Koch does not disclose a means for simple attachment and removal of a digital video camera to and from an optical sight. Furthermore, Koch fails to disclose a means for attaching a display device to a firearm.

US Pub. No.: 2012/0126002. Rudich

Rudich describes a digital video camera that is mounted on a firearm in such a way as to captore a target area. However, the invention described in Rudich replaces the use of a scope on a firearm. Therefore, Rudich fails to disclose a means for attaching a digital video camera to a scope or other optical device. Rudich also describes a viewing screen for displaying images captured by the video camera. However, Rudich does not disclose a means for attaching a display device to a firearm while allowing the display device to swivel.

U.S. Pat. No.: 4,290,219. Boller et al.

Boller describes a photographic camera attached to a telescopic sight that is operable to capture an image as seen through the telescopic sight when the trigger of a firearm is pulled. However, Boller fails to disclose a digital video camera attached to a telescopic sight. Furthermore, Boller does not disclose the means for easily attaching and removing a digital video camera to and from a telescopic sight. Moreover, Boiler fails to disclose a display device that can be attached to a firearm.

U.S. Pat. No.: 6,539,661. Hope

Hope describes a micro-camera attached to a scope by means of an encircling damp (specifically an Adel clamp or worm gear type hose clamp). However, Hope fails to disclose a display device that can be attached to a firearm.

None of the above inventions and patents, either singly or in combination, is seen to describe the instant invention as claimed.

2. Description of the Related Art

The history of using optical viewing, instruments such as scopes for hunting, telescopes for astronomy, microscope for scientific studies and other purposes has required the viewer to look through an eye piece with one or both eyes to view a scene or object. This type of viewing adds a layer of difficulty to using an optical viewing tool. The viewer may have to bend their body into a particular viewing position or hold their eye directly over the eye piece. Focusing the eye through an eye piece may also be difficult for persons with certain visual impairments. Physically holding the viewing instrument in a way required for viewing can be difficult for some persons. This invention captures the visual information coming through the lenses and coverts it into digital visual data that can he displayed on various electronic instruments and stored electronically. This invention enables a standard optical scope to be used to view video images in Infra-Red and other invisible light spectrums.

### BRIEF SUMMARY OF THE INVENTION

The present invention comprises various embodiments of an optical image capture instrument which is attachable to and removable from the eye bell, ocular lens encasement, or eyepiece view finder area on an optical viewing scope to capture live images that are projected through the scope and convert it into digital data that can be output and immediately viewed on a monitor, recorded, transmitted, or used in applications. The present invention can be attached to the viewing instrument as an attachment at any point on the housing which allows it to focus on a view of the images coming through the scope.

The present invention has a video display that is attachable to the scope, the rifle, independent structures, set on surfaces, or hand held. The display turns for viewing from multiple angles.

The present invention also has video output capabilities so the live field of view from the scope can be transmitted, stored, or displayed to any device with video input capabilities.

### BRIEF DESCRIPTION OF THE DRAWINGS

A better understanding of the present invention will he realized from the detailed description which follows, taken in conjunction with the accompanying drawings, in which;

FIG. 1. is an environmental perspective view of the present optical image capture device and a monitor in use with a firearm mounted scope, showing its general configuration and components.

FIG. 2a. is a drawing showing a side view of a typical rifle and a typical scope mounted on the back of the rifle using the present invention attached for targeting, with the targeting display mounted on the scope.

FIG. 2b. is a drawing showing a side view of a typical rifle and a typical scope with the scope mounted un-typically on a front rail of the rifle using the present invention attached for targeting with the targeting display attached on the rifle's front side Picatinny rail.

FIG. 3a. is a side sectional view of the eyepiece end of a firearm scope.

FIG. 3b. is a side sectional view of the present invention showing the component that attaches to the eyepiece of the scope and shows the video capture device that it contains.

FIG. 3c. is a side sectional view of the present invention showing the eyepiece of the scope with the present invention video capture device component attached.

FIG. 3d. is a side sectional view of the eyepiece end of a rifle scope with the video capture device component of the present invention attached.

FIG. 4a. is the back view of the video display module of the present invention showing how it connects to the rail mounting device of the present invention.

FIG. 4b. is a side view of the video display device rail mount of the present invention.

FIG. 5a. is an environmental perspective view of the present invention showing how the components are connected to the power source and means of transmitting video image data.

FIG. 5b. is a front view section of the current inventions power and video distribution component showing the wiring, power source and electrical components.

### DETAILED DESCRIPTION OF DRAWINGS AND BEST MODE OF IMPLEMENTATION

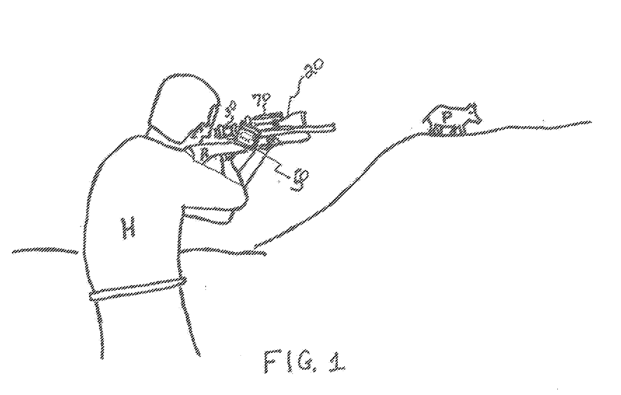

The present invention comprises various embodiments of an optical image capture and display device which is easily attachable and removable from an optical scope like a rifle scope. This device is attached in a way that enables the video image capture instrument to capture the real time images coming through the lens and or other mechanisms of the viewing instrument and transmit those images digitally to an electronic device. The instrument has video output connections that can be connected to monitors, transmitters, recorders, or any instrument with video input capabilities. The present invention includes a monitor that is attachable to and removable from the body of an optical scope or other viewing instrument. The monitor has electrical connections that can be connected to and disconnected from the optical video image capture instrument and a power supply. The primary purpose of this instrument is to enable the viewing of images without having to look into an eye piece. For example, in FIG. 1 the images coming through the lens of the rifle scope are displayed on the monitor mounted on the rifle scope. The shooter simply uses the video display in targeting the gun scope rather than having to look through the eye piece of the scope. The angle of the monitor is adjustable so the shooter can target the front multiple holding positions without requiring the traditional method of positioning the shooters eye behind the eye piece of the scope.

This instrument uses various video board camera types and formats, various board camera lenses, and optical focusing lenses that are installed in various housing designs which can be connected to and disconnected from an optical devise optical viewing area such as the eye piece on a rifle scope, microscope, telescope or similar optical viewing instrument. The board cameras technologies may be black and white, color, infra-red, 3 dimensional, thermal, or any other board camera technologies available. The board camera may also have audio capture and output capabilities. The prototype uses (see attachment 1) a board camera with infra-red night vision capabilities, a board camera 16 mm board lens and a optical lens installed in the housing. The camera and lens configurations for the present invention can be configured to meet any focusing requirements needed. The housing adapter that connects this invention to the scope, microscope, telescope or similar optical viewing instrument has various sizes to meet the requirements for attaching to differing sizes of scopes, telescopes, microscopes, and similar viewing instruments. The video output for the current invention also includes wireless connection options. The prototype is using a board camera with a wired video output jack, and DC power input connections.

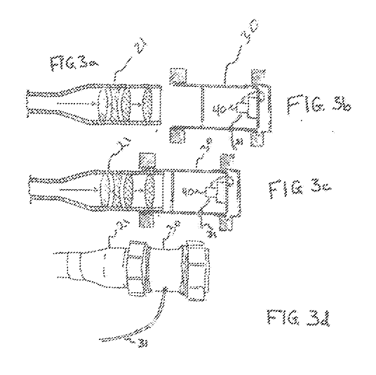

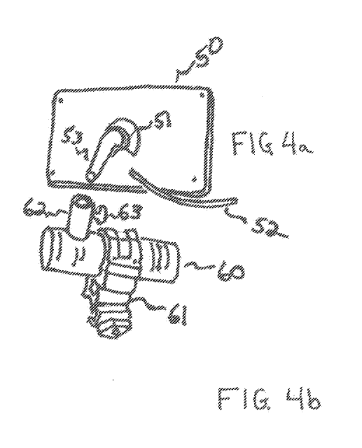

FIG. 1 provides an illustration of the general concept of the present is in which a hunter H is targeting a rifle R at a wild pig P. The hunter is targeting the pig using the video display 50 which shows the scope's 20 field of view. FIG. 1 shows the general concept of the present invention attached to a rifle scope. The invention is attached to the eyepiece of the scope (FIG. 3a, item 21), a housing that the scope tube gets attached to. The invention's video display attachment (FIG. 4a, item 50) is attached to the rifle using a component of this invention for connecting to a standard rail mounting system such as Picatinny, weaver, and dovetail. It can also be used without mounting. The shooter uses this inventions video display for viewing the scope's field of view and or targeting the gun rather than looking through the scope eye piece. The video display is attached to the rail system in such a way that its position can be rotated and swiveled to allow multiple viewing positions so the scope's eyepiece does no longer have to be positioned in line with the users eye for targeting or viewing.

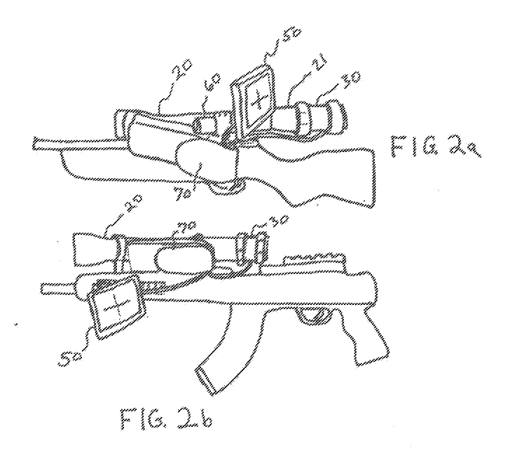

FIG. 2a. provides a side view of the present invention attached to a standard rifle. The rifle scope 20 is attached traditionally on a rail near the end of the rifle. The video display is attached to the Picatinny rail on the scope 20.

FIG. 2b provides a side vie of the present invention attached to a standard rifle. The rifle scope 20 is attached un-traditionally on a rail near the front end of the rifle. The video display is attached to the Picatinny rail on the front of the rifle.

FIG. 3a. is a side sectional view of the scope 20 eyepiece 21.

FIG. 3b. is a side sectional view of the present invention scope eyepiece attachment housing 30 showing the enclosed video capture device 40.

FIG. 3c. is a side sectional dew of the present invention scope eyepiece attachment housing 30 connected to the scope eyepiece 21 showing the field of view through the scope to the video capture device 40 in the present invention scope eyepiece attachment housing 30.

FIG. 3d is a side view of the present invention scope eyepiece attachment housing 30 connected to the scope eyepiece 21.

FIG. 4a. is a back view of the present invention video display 50 showing the ball joint swivel mount 51 and the wiring harness 52.

FIG. 4b. is a side view of the present invention video display 50 rail mount 60 for attaching the video display 50 to a gun rail mount system using a gun scope rail mount 61. The video display 50 is attached or detached by inserting the swivel pole 53 into the rail mount hole 62 and turning the tightening screw 63 to secure it.

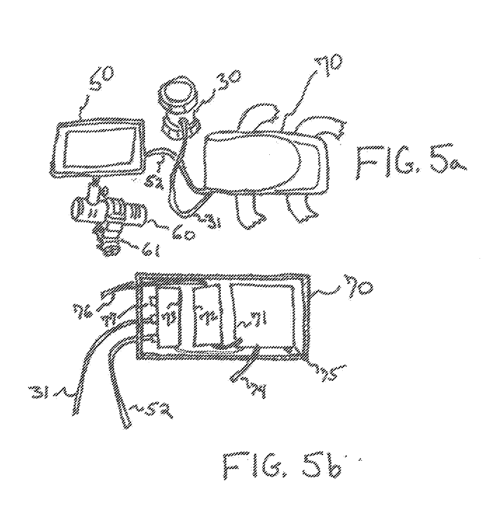

FIG. 5a. is a view of the current invention components video display 50, scope eyepiece attachment housing 30, video display 50 rail mount 60, and the VSPDU (video signal and power distribution unit) 70 connected.

FIG. 5b. is a side section view of the VSPDU (video signal and power distribution unit) 70 and shows the battery 71, voltage regulator 72, wiring harness 73, power on switch 75, battery recharge port 74, video display wiring harness input 52, video capture device wiring harness input 1, and variable voltage output 76 to power low voltage illuminators, transmitters, recorders, and other devices. The VSPDU 70 also contains a video output port 77.

It is to be understood that the present invention is not limited to the embodiments described above, but encompasses any and all embodiments within the scope of the following claims.

1. A scope attachment for converting visible and invisible electromagnetic radiation received through an optical rifle scope or telescope line of sight into visible video output that can be displayed, recorded, or transmitted comprising: a housing for attaching the video capture device to the scope eyepiece; a video capture device for converting electromagnetic radiation coming through the scope's optics into visible video; a video display device for displaying the video output from the video capture device; a power supply for powering the video capture device and video display device; a circuit electronically coupling the video capture device, the video display device, video output, and power supply.

2. A firearm rail attachable video display device that can easily be turned or swiveled to change the relative positioning of the viewing plan relative to the firearm comprising: a video display device; a harness for holding the video display that allows it to swivel and or turn to change viewing positions; a connecting apparatus that couples the video display harness to a firearm rail system;

3. A scope video viewer attachment apparatus that enables a firearm scope to be mounted and used on a firearm with the eyepiece inaccessible to the users eye while using the firearm comprising; a video capture device attachment according to claim 1; a video display according to claim 2; a circuit electronically coupling the video display devise and video capture device according to claim 1.
